(19) United States
(12) Patent Application Publication
(10) Pub. No.: US 2025/0361626 A1
(43) Pub. Date: Nov. 27, 2025

(54) ELECTROLYSIS DEVICE

(71) Applicant: HONDA MOTOR CO., LTD., TOKYO (JP)

(72) Inventor: Yuta HOSHI, WAKO-SHI (JP)

(21) Appl. No.: 19/210,103

(22) Filed: May 16, 2025

(30) Foreign Application Priority Data
May 27, 2024 (JP) 2024-085532

(51) Int. Cl. C25B 1/04; C25B 9/73; C25B 15/08

(52) U.S. Cl. CPC C25B 1/04; C25B 9/73; C25B 15/083; C25B 15/087

(57) ABSTRACT

An electrolysis device includes a water electrolysis stack configured to electrolyze water, a gas-liquid separator configured to separate hydrogen gas from water discharged from the water electrolysis stack, and a hydrogen compression stack configured to compress the hydrogen gas separated by the gas-liquid separator. The gas-liquid separator includes a storage tank configured to store water, and a maximum storage water level that is a maximum value of a water level that can be allowed in the storage tank is predetermined, and the hydrogen compression stack is located above the maximum storage water level.

### CROSS-REFERENCE TO RELATED APPLICATIONS

This application is based upon and claims the benefit of priority from Japanese Patent Application No. 2024-085532 filed on May 27, 2024, the contents of which are incorporated herein by reference.

### BACKGROUND OF THE INVENTION

### Field of the Invention

The present disclosure relates to an electrolysis device.

### Description of the Related Art

In recent years, research and development have been conducted on electrolysis devices that contribute to energy efficiency in order to ensure that more people have access to affordable, reliable, sustainable and modern energy.

JP 2022-029892 A discloses an electrolysis device including a water electrolysis stack that electrolyzes water, a gas-liquid separator that separates hydrogen gas from water discharged from the water electrolysis stack, and a hydrogen compression stack that compresses the hydrogen gas separated by the gas-liquid separator.

### SUMMARY OF THE INVENTION

There is a need for a better electrolysis device.

The present invention has the object of solving the aforementioned problem.

An aspect of the present disclosure is characterized by an electrolysis device including a water electrolysis stack configured to electrolyze water, a gas-liquid separator configured to separate hydrogen gas from water discharged from the water electrolysis stack, and a hydrogen compression stack configured to compress the hydrogen gas separated by the gas-liquid separator, wherein the gas-liquid separator includes a storage tank configured to store water, a maximum storage water level that is a maximum value of a water level allowable in the storage tank is predetermined, and the hydrogen compression stack is located above the maximum storage water level.

According to the present disclosure, a more satisfactory electrolysis device can be obtained.

The above and other objects, features, and advantages of the present invention will become more apparent from the following description when taken in conjunction with the accompanying drawings, in which preferred embodiments of the present invention is shown by way of illustrative example.

### BRIEF DESCRIPTION OF THE DRAWINGS

FIG. 1 is a perspective view of an electrolysis device;

FIG. 2 is a perspective view of the electrolysis device;

FIG. 3 is a plan view of the electrolysis device as viewed from above;

FIG. 4 is a partially omitted cross-sectional explanatory view with partial omission of the electrolysis device;

FIG. 5 is an explanatory diagram of an inclination state of the electrolysis device;

FIG. 6 is an explanatory diagram of an inclination state of the electrolysis device; and

FIG. 7 is a cross-sectional explanatory view with partial omission of the electrolysis device according to a modification.

### DETAILED DESCRIPTION OF THE INVENTION

A gas-liquid separator of an electrolysis device has a storage tank for storing water. When such an electrolysis device is mounted on a moving object, the electrolysis device may be inclined with respect to a horizontal plane. When the electrolysis device is inclined with respect to the horizontal plane, water (liquid water) stored in the storage tank may flow into a hydrogen compression stack. In this case, water may accumulate inside the hydrogen compression stack, and the hydrogen compression stack may not be capable of efficiently compressing hydrogen gas. The present disclosure can provide an electrolysis device that can suppress the inflow of water stored in a storage tank into a hydrogen compression stack and efficiently compress hydrogen gas.

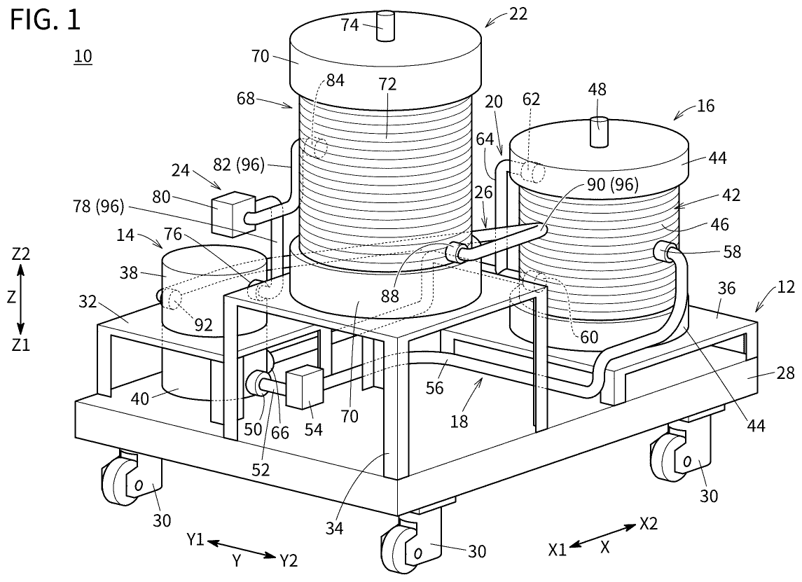

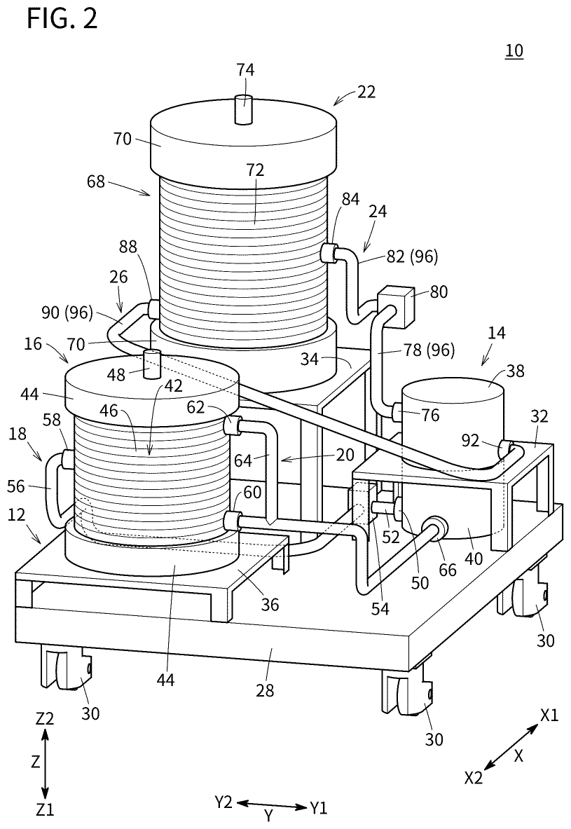

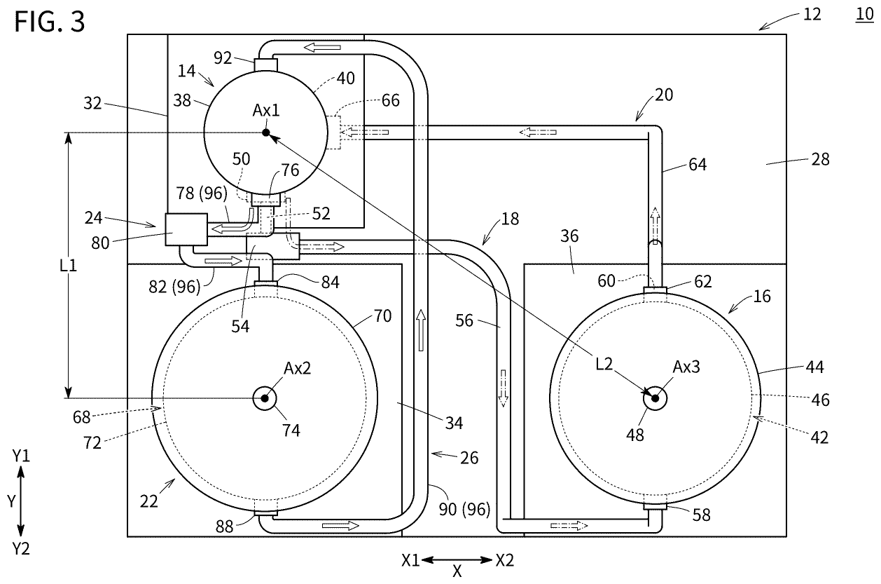

FIGS. 1 and 2 are perspective views of an electrolysis device 10. FIG. 3 is a plan view of the electrolysis device 10 as viewed from above. As shown in FIGS. 1 to 3, the electrolysis device 10 may be incorporated into, for example, a circulatory renewable energy system. The circulatory renewable energy system is a system in which the electrolysis device 10 and a fuel cell system (not shown) are combined. The fuel cell system generates electricity and water by an electrochemical reaction of oxygen gas and hydrogen gas. The electrolysis device 10 electrolyzes water to generate oxygen gas and hydrogen gas. The electrolysis device 10 uses water generated in the fuel cell system. The fuel cell system utilizes the oxygen gas and the hydrogen gas generated in the electrolysis device 10.

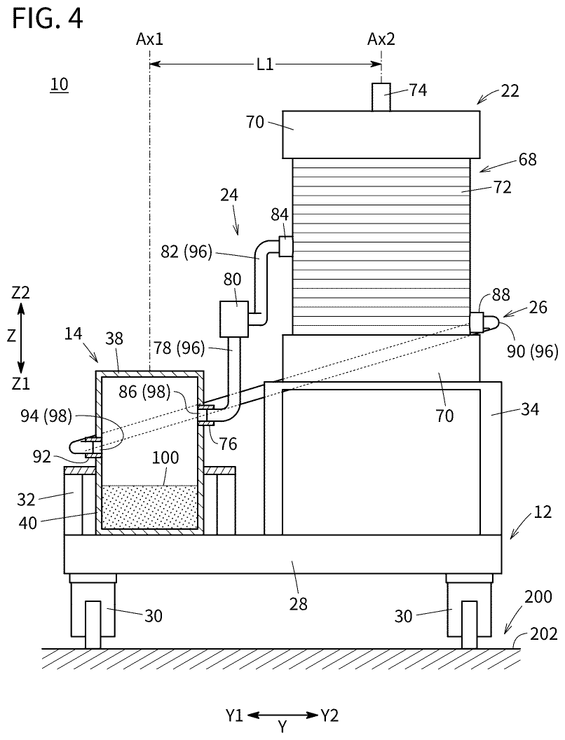

FIG. 4 is a partially omitted cross-sectional explanatory view with partial omission of the electrolysis device 10. As shown in FIG. 4, the electrolysis device 10 is mounted on a moving object 200. The electrolysis device 10 may be used for, for example, a probe for an extraterrestrial planet, but is not limited thereto. The moving object 200 is, for example, a vehicle, a flying object, or the like.

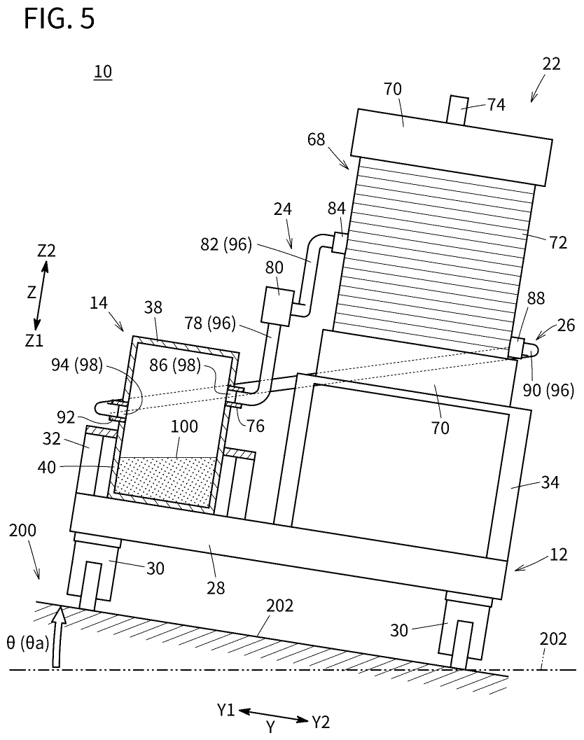

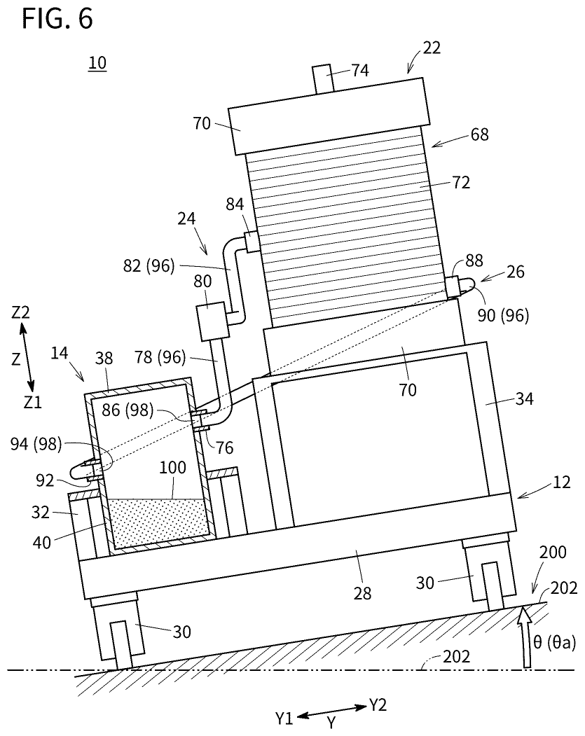

The electrolysis device 10 is formed as a single, integrated module. The electrolysis device 10 is installed on an installation surface 202 of the moving object 200. FIG. 4 illustrates a state in which the installation surface 202 on which the electrolysis device 10 is installed is horizontal (a state in which the electrolysis device 10 is not inclined). FIGS. 5 and 6 are explanatory diagrams of an inclination state of the electrolysis device 10. As shown in FIGS. 5 and 6, the installation surface 202 of the electrolysis device 10 may be inclined with respect to the horizontal plane depending on the posture of the moving object 200. In this case, the electrolysis device 10 is inclined with respect to the horizontal plane.

In the electrolysis device 10, a maximum angle θa of elevation or depression, which is a maximum allowable value of an angle θ of elevation or depression (an inclination angle with respect to the horizontal plane), is predetermined. That is, in the present embodiment, the electrolysis device 10 can be operated when the angle θ of elevation or depression is equal to or less than the maximum angle θa of elevation or depression.

As shown in FIGS. 1 to 3, the electrolysis device 10 includes a support member 12, a gas-liquid separator 14, a water electrolysis stack 16, a water supply flow path 18, a water discharge flow path 20, a hydrogen compression stack 22, a hydrogen gas supply flow path 24, and a hydrogen gas discharge flow path 26.

The support member 12 includes a base portion 28, a plurality of casters 30, a first support portion 32, a second support portion 34, and a third support portion 36. The base portion 28 extends in the X direction and the Y direction. The X direction is a direction perpendicular to the height direction (Z direction) of the electrolysis device 10. The Y direction is a direction perpendicular to the X direction and the Z direction. In a state where the electrolysis device 10 is not inclined, the X direction and the Y direction are horizontal directions. In addition, in the state where the electrolysis device 10 is not inclined, the Z direction, which is the height direction of the electrolysis device 10, is the vertical direction.

As shown in FIGS. 1, 2, and 4, the plurality of casters 30 are attached to a lower surface (a surface facing the Z1 direction) of the base portion 28. Accordingly, the entire electrolysis device 10 can be easily positioned with respect to the installation surface 202 of the moving object 200. Each of the casters 30 has a stopper (not shown) for locking the rotation of the wheel. The support member 12 need not necessarily include the casters 30. In such a case, the base portion 28 is directly installed on the installation surface 202 of the moving object 200.

As shown in FIGS. 1 to 3, the first support portion 32, the second support portion 34, and the third support portion 36 are attached to the base portion 28. The first support portion 32 supports the gas-liquid separator 14. The gas-liquid separator 14 may be attached to the first support portion 32 by an attachment member (not shown). The second support portion 34 supports the hydrogen compression stack 22. The third support portion 36 supports the water electrolysis stack 16.

In the present embodiment, the gas-liquid separator 14 and the hydrogen compression stack 22 are arranged in parallel in the Y direction. The water electrolysis stack 16 and the hydrogen compression stack 22 are arranged in parallel in the X direction. In particular, the gas-liquid separator 14 is located in the Y1 direction with respect to the hydrogen compression stack 22. In other words, the hydrogen compression stack 22 is located in the Y2 direction, which is the opposite direction to the Y1 direction, with respect to the gas-liquid separator 14. The hydrogen compression stack 22 is located in the X1 direction with respect to the water electrolysis stack 16. In other words, the water electrolysis stack 16 is located in the X2 direction, which is the opposite direction to the X1 direction, with respect to the hydrogen compression stack 22.

Auxiliary devices (not shown) can be attached to the base portion 28. The auxiliary devices may include, for example, an ion exchanger, a heat exchanger, an on-off valve, a pipe, and the like. The auxiliary devices may be disposed in, for example, empty spaces of the base portion 28 adjacent to the gas-liquid separator 14 in the X2 direction.

The arrangement of the gas-liquid separator 14, the water electrolysis stack 16, and the hydrogen compression stack 22 is not limited to the example described above, and can be set as appropriate. For example, the support member 12 may not include the third support portion 36. That is, the water electrolysis stack 16 may be directly disposed on the base portion 28.

As shown in FIGS. 1 to 4, the gas-liquid separator 14 includes a gas-liquid separator body 38 and a storage tank 40. The gas-liquid separator body 38 separates the fluid (mixed fluid of hydrogen gas and water) discharged from the water electrolysis stack 16 into gas and liquid. The gas-liquid separator body 38 is formed in, for example, a cylindrical shape. The gas-liquid separator body 38 extends in the Z direction.

The storage tank 40 stores water (liquid water). The storage tank 40 is provided below the gas-liquid separator body 38. The inside of the storage tank 40 communicates with the inside of the gas-liquid separator body 38 (see FIG. 4). The storage tank 40 is formed in a cylindrical shape, for example. The water separated by the gas-liquid separator body 38 can be stored in the storage tank 40. Water may be introduced into the storage tank 40 from outside.

The gas-liquid separator 14 may include components other than the components described above. The size, shape, and the like of the gas-liquid separator 14 can be set as appropriate.

An unillustrated first electrical power source, which is a DC power source, is connected to the water electrolysis stack 16. As shown in FIGS. 1 to 3, the water electrolysis stack 16 electrolyzes water by supplying a current from a DC power source. The water electrolysis stack 16 thereby generates hydrogen gas and oxygen gas. The water electrolysis stack 16 is, for example, a differential pressure type water electrolysis stack capable of producing high-pressure oxygen gas. The water electrolysis stack 16 may be an isobaric water electrolysis stack.

As shown in FIGS. 1 and 2, the water electrolysis stack 16 is formed in a columnar shape, for example. The water electrolysis stack 16 includes a cell stacked body 42 and a pair of end plates 44. The cell stacked body 42 includes a plurality of water electrolysis cells 46. The plurality of water electrolysis cells 46 are stacked in the Z direction.

Although not shown in detail, each of the water electrolysis cells 46 includes a membrane electrode assembly and a pair of separators. The membrane electrode assembly is sandwiched between a pair of separators in the Z direction. The membrane electrode assembly includes an electrolyte membrane, a cathode, and an anode. The electrolyte membrane is an ion exchange membrane. A voltage is applied between the cathode and the anode by a first electrical power source.

The pair of end plates 44 sandwich the cell stacked body 42 in the Z direction. An oxygen gas pipe 48 for transporting the oxygen-gas generated in the water electrolysis stack 16 to outside (for example, an unillustrated oxygen gas tank) is connected to the end plate 44 located on the upper side (in the Z2 direction).

In order to lower the center of gravity position of the electrolysis device 10, the lower surface of the water electrolysis stack 16 is located relatively close to the base portion 28.

As shown in FIGS. 1 to 3, the water supply flow path 18 supplies water stored in the storage tank 40 to the water electrolysis stack 16. The water supply flow path 18 includes a water outlet portion 50, a first water supply pipe 52, a water pump 54, a second water supply pipe 56, and a water inlet portion 58.

The water outlet portion 50 is connected to the storage tank 40. The water outlet portion 50 has a water outlet port (hole) (not shown) for guiding water from the storage tank 40 to outside. The water outlet portion 50 protrudes from the storage tank 40 in the Y2 direction. The first water supply pipe 52 connects the water outlet portion 50 and the water pump 54. The water pump 54 pressure-feeds water toward the water electrolysis stack 16. The second water supply pipe 56 connects the water pump 54 and the water inlet portion 58.

The water inlet portion 58 is connected to the water electrolysis stack 16. The water inlet portion 58 is formed with a water inlet port (hole), not shown, for introducing water into the water electrolysis stack 16. The water inlet portion 58 is located at a central part of the cell stacked body 42 in the up-down direction (see FIGS. 1 and 2). The water inlet portion 58 protrudes from the cell stacked body 42 in the Y2 direction. Accordingly, a part of the second water supply pipe 56 can be positioned in the Y2 direction of the water electrolysis stack 16, and thus the water electrolysis stack 16 can be protected from impact in the Y2 direction (from the outside of the electrolysis device 10), by the second water supply pipe 56.

As shown in FIGS. 2 and 3, the water discharge flow path discharges the hydrogen gas generated in the water electrolysis stack 16 and non-reacted water to the storage tank 40. The water discharge flow path 20 includes a first water outlet portion 60, a second water outlet portion 62, a drain pipe 64, and a water return portion 66.

The first water outlet portion 60 and the second water outlet portion 62 are connected to the water electrolysis stack 16. Each of the first water outlet portion 60 and the second water outlet portion 62 is provided with a water outlet port (hole) (not shown) for guiding water from the inside of the water electrolysis stack 16 to outside. The first water outlet portion 60 is located at the lower end portion of the cell stacked body 42. The second water outlet portion 62 is located at the upper end portion of the cell stacked body 42. Each of the first water outlet portion 60 and the second water outlet portion 62 protrudes from the cell stacked body 42 in the Y1 direction.

The drain pipe 64 guides the non-reacted water and the hydrogen gas guided from the first water outlet portion 60 and the second water outlet portion 62 to the water return portion 66. The water return portion 66 is connected to the storage tank 40. The water return portion 66 is formed with a water return port (hole) (not shown) for returning the non-reacted water and the hydrogen gas discharged from the water electrolysis stack 16 to the inside of the storage tank 40 (gas-liquid separator 14).

An unillustrated second electrical power source, which is a DC power source, is connected to the hydrogen compression stack 22. As shown in FIGS. 1 to 4, the hydrogen compression stack 22 can compress the hydrogen gas by supplying a current from a DC power source.

The hydrogen compression stack 22 is formed in a columnar shape, for example. The hydrogen compression stack 22 includes a cell stacked body 68 and a pair of end plates 70. The cell stacked body 68 includes a plurality of compression cells 72. The plurality of compression cells 72 are stacked in the Z direction.

Although not shown in detail, each of the compression cells 72 includes a membrane electrode assembly and a pair of separators. The membrane electrode assembly is sandwiched between a pair of separators in the Z direction. The membrane electrode assembly includes an electrolyte membrane, a cathode, and an anode. The electrolyte membrane is an ion exchange membrane. A voltage is applied between the cathode and the anode by a second electrical power source.

The pair of end plates 70 sandwich the cell stacked body 68 in the Z direction. A hydrogen gas pipe 74 for transporting the hydrogen gas for compression, which is generated in the hydrogen compression stack 22 to outside (for example, an unillustrated hydrogen gas tank), is connected to the end plate 70 located on the upper side.

As shown in FIGS. 1 and 2, the position of the lower surface of the hydrogen compression stack 22 in the height direction is higher than the position of the lower surface of the water electrolysis stack 16 in the height direction. The position of the lower surface of the hydrogen compression stack 22 in the height direction is lower than the position of the upper surface of the water electrolysis stack 16 in the height direction. The position of the upper surface of the hydrogen compression stack 22 in the height direction is higher than the position of the upper surface of the water electrolysis stack 16 in the height direction. In other words, in a state where the electrolysis device 10 is not inclined, a height position of the upper surface (upper end) of the water electrolysis stack 16 in the vertical direction is lower than a height position of the upper surface (upper end) of the hydrogen compression stack 22 in the vertical direction.

As shown in FIGS. 1 to 4, the hydrogen gas supply flow path 24 supplies the hydrogen gas from the gas-liquid separator 14 to the hydrogen compression stack 22. The hydrogen gas supplied from the gas-liquid separator 14 to the hydrogen compression stack 22 contains an appropriate amount of moisture. The electrolyte membranes of the compression cells 72 are humidified by the moisture. The hydrogen gas supply flow path 24 includes a hydrogen gas outlet portion 76, a first hydrogen gas supply pipe 78, a hydrogen pump 80, a second hydrogen gas supply pipe 82, and a hydrogen gas inlet portion 84.

The hydrogen gas outlet portion 76 is connected to the gas-liquid separator body 38. A hydrogen gas outlet port 86 (hole) for allowing the hydrogen gas to be guided from the gas-liquid separator body 38 to outside is formed in the hydrogen gas outlet portion 76 (see FIG. 4). The hydrogen gas outlet portion 76 protrudes from the gas-liquid separator body 38 in the Y2 direction. The position of the hydrogen gas outlet portion 76 in the height direction is lower than the position of the lower surface of the hydrogen compression stack 22 in the height direction.

The first hydrogen gas supply pipe 78 connects the hydrogen gas outlet portion 76 and the hydrogen pump 80. In a state where the electrolysis device 10 is not inclined, the first hydrogen gas supply pipe 78 ascends from the hydrogen gas outlet portion 76 to the hydrogen pump 80 without descending. In other words, in the state where the electrolysis device 10 is not inclined, the first hydrogen gas supply pipe 78 descends from the hydrogen pump 80 to the hydrogen gas outlet portion 76 without ascending. Accordingly, water droplets condensed on the inner surface of the first hydrogen gas supply pipe 78 can be caused to flow to the gas-liquid separator body 38 by gravity. The hydrogen pump 80 pressure-feeds the hydrogen gas toward the hydrogen compression stack 22. Although not shown in detail, the hydrogen pump 80 may be supported by the support member 12. The position of the hydrogen pump 80 in the height direction is higher than the position of the hydrogen gas outlet portion 76 in the height direction.

The second hydrogen gas supply pipe 82 connects the hydrogen pump 80 and the hydrogen gas inlet portion 84. In a state where the electrolysis device 10 is not inclined, the second hydrogen gas supply pipe 82 ascends from the hydrogen pump 80 to the hydrogen gas inlet portion 84 without descending. In other words, in the state where the electrolysis device 10 is not inclined, the second hydrogen gas supply pipe 82 descends from the hydrogen gas inlet portion 84 to the hydrogen pump 80 without ascending. Thus, water droplets condensed on the inner surface of the second hydrogen gas supply pipe 82 can be caused to flow to the gas-liquid separator body 38 via the hydrogen pump 80 and the first hydrogen gas supply pipe 78 by gravity. Therefore, it is possible to suppress the introduction of the condensed water from the hydrogen gas supply flow path 24 into the hydrogen compression stack 22.

The hydrogen gas inlet portion 84 is connected to the hydrogen compression stack 22. The hydrogen gas inlet portion 84 is formed with a hydrogen gas inlet port (hole) (not shown) for introducing the hydrogen gas into the hydrogen compression stack 22. The hydrogen gas inlet portion 84 is located at the central part of the cell stacked body 68 in the up-down direction. The hydrogen gas inlet portion 84 protrudes from the cell stacked body 68 in the Y1 direction. As shown in FIGS. 1, 2, and 4, the position of the hydrogen gas inlet portion 84 in the height direction is higher than the position of the hydrogen pump 80 in the height direction. The position of the hydrogen gas inlet portion 84 in the height direction is higher than the position of the hydrogen gas outlet portion 76 in the height direction.

As shown in FIGS. 1 to 4, the hydrogen gas discharge flow path 26 returns non-reacted hydrogen gas that has not reacted in the hydrogen compression stack 22 and surplus moisture to the gas-liquid separator 14. The hydrogen gas discharge flow path 26 includes a hydrogen gas outlet portion 88, a hydrogen gas outlet pipe 90, and a hydrogen gas return portion 92. The hydrogen gas outlet portion 88 is connected to the hydrogen compression stack 22. The hydrogen gas outlet portion 88 is formed with a hydrogen gas outlet port (hole) (not shown) for guiding the non-reacted hydrogen gas and the surplus moisture to outside. The hydrogen gas outlet portion 88 is located at the lower end portion of the cell stacked body 68. The hydrogen gas outlet portion 88 protrudes from the cell stacked body 68 in the Y2 direction. Accordingly, a part of the hydrogen gas outlet pipe 90 connected to the hydrogen gas outlet portion 88 can be positioned in the Y2 direction of the hydrogen compression stack 22, and thus the hydrogen compression stack 22 can be protected from impact in the Y2 direction (from the outside of the electrolysis device 10), by the hydrogen gas outlet pipe 90. The position of the hydrogen gas outlet portion 88 in the height direction is lower than the position of the hydrogen gas inlet portion 84 in the height direction (see FIGS. 1, 2, and 4).

The hydrogen gas outlet pipe 90 connects the hydrogen gas outlet portion 88 and the hydrogen gas return portion 92. In a state where the electrolysis device 10 is not inclined, the hydrogen gas outlet pipe 90 descends from the hydrogen gas outlet portion 88 to the hydrogen gas return portion 92 without ascending. In other words, in the state where the electrolysis device 10 is not inclined, the hydrogen gas outlet pipe 90 ascends from the hydrogen gas return portion 92 to the hydrogen gas outlet portion 88 without descending. Thus, water droplets condensed on the inner surface of the hydrogen gas outlet pipe 90 can be caused to flow to the gas-liquid separator body 38 by gravity.

The hydrogen gas return portion 92 is connected to the gas-liquid separator body 38. A hydrogen gas return port 94 (hole) for returning the non-reacted hydrogen gas and the surplus moisture guided by the hydrogen gas outlet pipe 90 to the inside of the gas-liquid separator 14 is formed in the hydrogen gas return portion 92. As shown in FIGS. 1, 2, and 4, the position of the hydrogen gas return portion 92 in the height direction is lower than the position of the hydrogen gas outlet portion 88 in the height direction. The position of the hydrogen gas return portion 92 in the height direction is lower than the position of the hydrogen gas outlet portion 76 in the height direction. That is, the position of the hydrogen gas outlet port 86 in the height direction is higher than the position of the hydrogen gas return port 94 in the height direction (see FIG. 4).

As shown in FIG. 4, in the present embodiment, the electrolysis device 10 includes a pipe 96 that connects the gas-liquid separator 14 and the hydrogen compression stack 22. The pipe 96 includes the first hydrogen gas supply pipe 78, the second hydrogen gas supply pipe 82, and the hydrogen gas outlet pipe 90. In a state where the electrolysis device 10 is not inclined, the pipe 96 ascends from the gas-liquid separator 14 toward the hydrogen compression stack 22 without descending. In the present embodiment, the storage tank 40 is provided with hydrogen flow path openings 98. The hydrogen flow path openings 98 include the hydrogen gas outlet port 86 and the hydrogen gas return port 94.

In the present embodiment, a maximum storage water level 100, which is a maximum value of the water level that can be allowed by the storage tank 40, is predetermined. FIG. 4 shows a state in which water is stored in the storage tank 40 up to the maximum storage water level 100. The hydrogen compression stack 22 is located above the maximum storage water level 100. Specifically, the lower surface of the hydrogen compression stack 22 is located above the maximum storage water level 100. That is, each of the hydrogen gas inlet portion 84 and the hydrogen gas outlet portion 88 is located above the maximum storage water level 100.

The hydrogen gas return port 94 is located above the maximum storage water level 100. According to this structure, it is possible to prevent the water stored in the storage tank from flowing into the hydrogen gas return portion 92 through the hydrogen gas return port 94 and blocking or narrowing the flow path of the hydrogen gas return portion 92. Accordingly, since it is possible to discharge the non-reacted hydrogen gas and the water smoothly from the hydrogen compression stack 22, the water is prevented from remaining in the hydrogen compression stack 22.

In a state where the electrolysis device 10 is not inclined, the hydrogen flow path openings 98 are located above the maximum storage water level 100. Specifically, as shown in FIG. 5, even when the electrolysis device 10 in which the storage tank 40 is filled with water up to the maximum storage water level 100 is inclined downward in the Y2 direction to the maximum angle Oa of elevation or depression, the height positions of the hydrogen flow path openings 98 in the vertical direction are higher than the position of the upper end of the maximum storage water level 100 of the storage tank 40 in the vertical direction.

Further, as shown in FIG. 6, even when the electrolysis device 10 in which the storage tank 40 is filled with water up to the maximum storage water level 100 is inclined downward in the Y1 direction to the maximum angle θa of elevation or depression, the height positions of the hydrogen flow path openings 98 in the vertical direction are higher than the position of the upper end of the maximum storage water level 100 of the storage tank 40 in the vertical direction. Accordingly, even when the electrolysis device 10 in which the storage tank 40 is filled with water up to the maximum storage water level 100 is inclined, it is possible to suppress the water stored in the storage tank 40 flowing into the pipe 96.

In the present embodiment, as shown in FIG. 3, a length L1 between the gas-liquid separator 14 and the hydrogen compression stack 22 is shorter than a length L2 between the gas-liquid separator 14 and the water electrolysis stack 16. The length L1 is the shortest length between an axis Ax1 of the gas-liquid separator 14 and an axis Ax2 of the hydrogen compression stack 22. The length L2 is the shortest length between the axis Ax1 of the gas-liquid separator 14 and an axis Ax3 of the water electrolysis stack 16.

As shown in FIG. 4, the electrolysis device 10 becomes larger as the length L1 becomes larger. The positions of the hydrogen gas inlet portion 84 and the hydrogen gas outlet portion 88 in the height direction increase as the length L1 increases. That is, as the length L1 increases, the length from the base portion 28 to the hydrogen compression stack 22 needs to be increased, and thus the size of the electrolysis device in the height direction increases and the center of gravity position of the electrolysis device 10 becomes higher. When the length L1 is shorter than the length L2 as in the present embodiment, the electrolysis device 10 can be configured to be relatively compact, and the center of gravity position of the electrolysis device 10 can be lowered.

Next, the operation of the electrolysis device 10 will be briefly described. In the electrolysis device 10, when the water pump 54 is driven, the water stored in the storage tank is supplied to the water electrolysis stack 16 via the water supply flow path 18. In the water electrolysis stack 16, water is electrolyzed by supplying a current from the first electrical power source, and oxygen gas and hydrogen gas are generated. The oxygen gas generated in the water electrolysis stack 16 is transported to the outside via the oxygen gas pipe 48. The hydrogen gas generated in the water electrolysis stack 16 and the non-reacted water are guided to the gas-liquid separator 14 via the water discharge flow path 20. The gas-liquid separator 14 separates the hydrogen gas and the water.

When the hydrogen pump 80 is driven, the hydrogen gas in the gas-liquid separator 14 is guided to the anode of the hydrogen compression stack 22 together with an appropriate amount of moisture, through the hydrogen gas supply flow path 24. In the hydrogen compression stack 22, a current is supplied from the second electrical power source, and thereby hydrogen gas is generated at the cathode. The hydrogen gas generated at the cathode is transported to the outside via the hydrogen gas pipe 74. The non-reacted hydrogen gas that has not reacted in the hydrogen compression stack 22 and the surplus water are returned to the gas-liquid separator 14 via the hydrogen gas discharge flow path 26.

According to the present embodiment, since the hydrogen compression stack 22 is located above the maximum storage water level 100, the water stored in the storage tank 40 can be prevented from flowing into the hydrogen compression stack 22. According to this configuration, the water stored in the storage tank 40 is prevented from flowing into the hydrogen compression stack 22 and remaining in the hydrogen compression stack 22. Therefore, the hydrogen gas can be efficiently compressed by the hydrogen compression stack 22. Therefore, a more satisfactory electrolysis device 10 can be obtained.

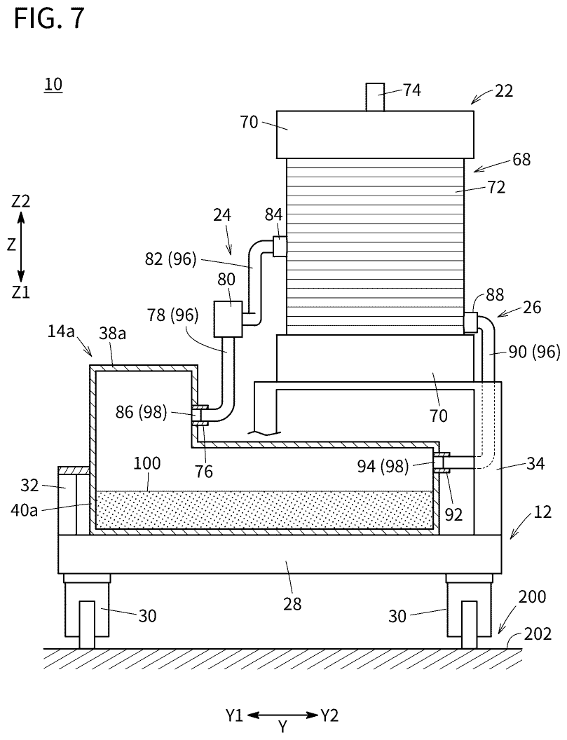

FIG. 7 is a cross-sectional explanatory view with partial omission of the electrolysis device 10 according to a modification. As shown in FIG. 7, the electrolysis device 10 may include a gas-liquid separator 14a instead of the above-described gas-liquid separator 14. The gas-liquid separator 14a has a gas-liquid separator body 38a and a storage tank 40a. At least a part of the gas-liquid separator 14a is located below (in the Z1 direction) the hydrogen compression stack 22. In this modification, a part of the gas-liquid separator body 38a and a part of the storage tank 40a are located below the hydrogen compression stack 22. In this case, for example, the hydrogen gas return portion 92 can be disposed relatively close to the hydrogen gas outlet portion 88, and thus the length of the hydrogen gas outlet pipe 90 can be shortened. Consequently, it is possible to configure the electrolysis device 10 more compactly.

The following supplementary notes are further disclosed in relation to the above-described embodiments.

### Supplementary Note 1

The electrolysis device (10) according to the present disclosure includes the water electrolysis stack (16) configured to electrolyze water, the gas-liquid separator (14, 14a) configured to separate the hydrogen gas from water discharged from the water electrolysis stack, and the hydrogen compression stack (22) configured to compress the hydrogen gas separated by the gas-liquid separator, wherein the gas-liquid separator includes the storage tank (40, 40a) configured to store the water, the maximum storage water level (100) that is the maximum value of a water level allowable in the storage tank is predetermined, and the hydrogen compression stack is located above the maximum storage water level.

In accordance with such a configuration, it is possible to suppress the water stored in the storage tank flowing into the hydrogen compression stack. Consequently, it is possible to suppress the water stored in the storage tank, flowing into the hydrogen compression stack and remaining in the inside of the hydrogen compression stack. Therefore, the hydrogen gas can be efficiently compressed by the hydrogen compression stack. Therefore, a more satisfactory electrolysis device can be obtained.

### Supplementary Note 2

In the electrolysis device according to Supplementary Note 1, the hydrogen compression stack may include the hydrogen gas inlet portion (84) from which hydrogen gas is introduced into the inside of the hydrogen compression stack, and the hydrogen gas outlet portion (88) from which the non-reacted hydrogen gas is guided from the inside of the hydrogen compression stack, and the hydrogen gas inlet portion and the hydrogen gas outlet portion may be located above the maximum storage water level.

In accordance with such a configuration, it is possible to suppress the water stored in the storage tank flowing into the hydrogen gas inlet portion and the hydrogen gas outlet portion.

### Supplementary Note 3

In the electrolysis device according to Supplementary Note 2, the gas-liquid separator may include the hydrogen gas return port (94) through which the non-reacted hydrogen gas and the water guided from the hydrogen gas outlet portion are returned to the inside of the gas-liquid separator, and the hydrogen gas return port may be located above the maximum storage water level.

In accordance with such a configuration, it is possible to suppress the water stored in the storage tank, flowing from the hydrogen gas return port into the pipe connecting the hydrogen gas outlet portion and the hydrogen gas return port and blocking or narrowing the flow path of the pipe. Accordingly, since it is possible to discharge the non-reacted hydrogen gas and the water smoothly from the hydrogen compression stack, it is further possible to suppress the water remaining in the hydrogen compression stack. The water is generated mainly due to dew condensation caused by a decrease in the temperature of wet gas during a stopped state of the electrolysis device.

### Supplementary Note 4

In the electrolysis device according to any one of Supplementary Notes 1 to 3, the maximum angle (θa) of elevation or depression, which is the maximum allowable value of the angle (θ) of elevation or depression, may be predetermined for the electrolysis device, and even when the electrolysis device in which the storage tank is filled with water to the maximum storage water level is inclined up to the maximum angle of elevation or depression, the height position of the hydrogen flow path opening (98) provided in the storage tank in the vertical direction may be higher than the maximum storage water level of the storage tank.

In accordance with such a configuration, even when the electrolysis device is inclined up to the maximum angle of elevation or depression, it is possible to suppress the water stored in the storage tank flowing into the hydrogen flow path opening.

### Supplementary Note 5

In the electrolysis device according to any one of Supplementary Notes 1 to 4, the distance (L1) between the gas-liquid separator and the hydrogen compression stack may be shorter than the distance (L2) between the gas-liquid separator and the water electrolysis stack.

In accordance with such a configuration, since the distance between the gas-liquid separator and the hydrogen compression stack can be made relatively short, the positions of the hydrogen gas inlet portion and the hydrogen gas outlet portion in the height direction can be lowered. Therefore, the electrolysis device can be configured compactly, and the center of gravity position of the electrolysis device can be lowered.

### Supplementary Note 6

In the electrolysis device according to any one of Supplementary Notes 1 to 5, in the state where the electrolysis device is not inclined, the pipe (96) connecting the gas-liquid separator and the hydrogen compression stack may ascend from the gas-liquid separator toward the hydrogen compression stack without descending.

In accordance with such a configuration, the water droplets condensed on the inner surface of the pipe can be guided to the gas-liquid separator by gravity. In addition, even if the water stored in the storage tank flows into the pipe when the electrolysis device is inclined, the water in the pipe can be returned into the gas-liquid separator when the electrolysis device returns to a state in which the electrolysis device is not inclined.

### Supplementary Note 7

In the electrolysis device according to any one of Supplementary Notes 1 to 6, at least a part of the gas-liquid separator may be located below the hydrogen compression stack.

In accordance with such a configuration, the electrolysis device can be configured to be more compact.

### Supplementary Note 8

In the electrolysis device according to any one of Supplementary Notes 1 to 7, in the state where the electrolysis device is not inclined, the height position of the upper end of the water electrolysis stack in the vertical direction may be lower than the height position of the upper end of the hydrogen compression stack in the vertical direction.

In accordance with such a configuration, since the water electrolysis stack is disposed at a relatively low position, the center of gravity position of the electrolysis device can be lowered.

While the present disclosure has been described in detail, the present disclosure is not limited to the individual embodiments described above. Within a range that does not depart from the essence and gist of the present disclosure, or within a range that does not depart from the gist and essence of the present disclosure derived from the content described in the claims and equivalents thereof, various additions, substitutions, changes, partial deletions, or the like can be made to such embodiments. These embodiments may also be implemented in combination. For example, in the embodiments described above, the order of the operations and the order of the processes are shown as examples, and the present invention is not limited to such operations and processes. The same applies to the case where numerical values or mathematical expressions are used in the description of the above-described embodiments.

1. An electrolysis device comprising:
a water electrolysis stack configured to electrolyze water;
a gas-liquid separator configured to separate hydrogen gas from water discharged from the water electrolysis stack; and
a hydrogen compression stack configured to compress the hydrogen gas separated by the gas-liquid separator,
wherein the gas-liquid separator includes a storage tank configured to store water,
a maximum storage water level that is a maximum value of a water level allowable in the storage tank is predetermined, and
the hydrogen compression stack is located above the maximum storage water level.

2. The electrolysis device according to claim 1, wherein the hydrogen compression stack includes:
a hydrogen gas inlet portion from which hydrogen gas is introduced into an inside of the hydrogen compression stack; and
a hydrogen gas outlet portion from which a non-reacted hydrogen gas is guided from the inside of the hydrogen compression stack, and
wherein the hydrogen gas inlet portion and the hydrogen gas outlet portion are located above the maximum storage water level.

3. The electrolysis device according to claim 2, wherein the gas-liquid separator includes a hydrogen gas return port through which the non-reacted hydrogen gas and water guided from the hydrogen gas outlet portion are returned to an inside of the gas-liquid separator, and
the hydrogen gas return port is located above the maximum storage water level.

4. The electrolysis device according to claim 1, wherein a maximum angle of elevation or depression, which is a maximum allowable value of an angle of elevation or depression, is predetermined for the electrolysis device, and
even when the electrolysis device in which the storage tank is filled with water to the maximum storage water level is inclined up to the maximum angle of elevation or depression, a height position of a hydrogen flow path opening provided in the storage tank in a vertical direction is higher than the maximum storage water level of the storage tank.

5. The electrolysis device according to claim 1, wherein a distance between the gas-liquid separator and the hydrogen compression stack is shorter than a distance between the gas-liquid separator and the water electrolysis stack.

6. The electrolysis device according to claim 1, wherein in a state where the electrolysis device is not inclined, a pipe connecting the gas-liquid separator and the hydrogen compression stack ascends from the gas-liquid separator toward the hydrogen compression stack without descending.

7. The electrolysis device according to claim 1, wherein at least a part of the gas-liquid separator is located below the hydrogen compression stack.

8. The electrolysis device according to claim 1, wherein in a state where the electrolysis device is not inclined, a height position of an upper end of the water electrolysis stack in a vertical direction is lower than a height position of an upper end of the hydrogen compression stack in the vertical direction.
